(19) United States
(12) Patent Application Publication
(10) Pub. No.: US 2014/0079116 A1
(43) Pub. Date: Mar. 20, 2014

(54) INDICATION OF INTERLACED VIDEO DATA FOR VIDEO CODING

(71) Applicant: QUALCOMM Incorporated, San Diego, CA (US)

(72) Inventor: Ye-Kui Wang, San Diego, CA (US)

(73) Assignee: QUALCOMM Incorporated, San Diego, CA (US)

(21) Appl. No.: 14/029,050

(22) Filed: Sep. 17, 2013

Related U.S. Application Data
(60) Provisional application No. 61/703,662, filed on Sep. 20, 2012.
(60) Provisional application No. 61/706,647, filed on Sep. 27, 2012.

(51) Int. Cl. H04N 7/26

(52) U.S. Cl. CPC H04N 19/00224
USPC 375/240.02

(57) ABSTRACT

This disclosure proposes techniques for encoding and video data. The techniques of the disclosure receiving a first indication that indicates whether all pictures in received video data are progressive frames coded as frame pictures. If a video decoder is unable to decode progressive frames, the video data may be rejected based on the first indication.

This Application claims the benefit of U.S. Provisional Application No. 61/703,662, filed on Sep. 20, 2012, and U.S. Provisional Application No. 61/706,647, filed on Sep. 27, 2012, the entire content of both of which is incorporated herein by reference.

### TECHNICAL FIELD

This disclosure relates to video coding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information more efficiently by implementing such video compression techniques.

Video compression techniques perform spatial (intra-picture) prediction and/or temporal (inter-picture) prediction to reduce or remove redundancy inherent in video sequences. For block-based video coding, a video slice (i.e., a video frame or a portion of a video frame) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to a reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

### SUMMARY

In general, this disclosure describes techniques for signaling and using an indication that video data is coded using interlacing.

According to one example of the disclosure, a method for decoding video data comprises receiving video data, receiving a first indication that indicates whether all pictures in the received video data are progressive frames coded as frame pictures, and decoding the received video data in accordance with the received first indication.

According to another example of the disclosure, a method for encoding video data comprises encoding video data, generating a first indication that indicates whether all pictures in the encoded video data are progressive frames coded as frame pictures, and signaling the first indication in an encoded video bitstream.

The techniques of this disclosure are also described in terms of apparatuses configured to execute the techniques, as well as computer-readable storage medium storing instructions that cause one more processors to perform the techniques.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system that may utilize the techniques described in this disclosure.

FIGS. 2A-2C are conceptual diagrams showing sampling locations in top and bottom fields for different chroma sub-sampling formats.

FIG. 3 is a block diagram illustrating an example video encoder that may implement the techniques described in this disclosure.

FIG. 4 is a block diagram illustrating an example video decoder that may implement the techniques described in this disclosure.

FIG. 5 is a flowchart illustrating an example video encoding method according to one example of the disclosure.

FIG. 6 is a flowchart illustrating an example video decoding method according to one example of the disclosure.

### DETAILED DESCRIPTION

This disclosure describes techniques for signaling and using an indication that video data is coded using interlacing. A bitstream coded according to the high efficiency video coding (HEVC) standard may contain the following types of coded pictures:

Progressive frames coded in frame pictures (progressive scan video)

Interlaced fields coded in frame pictures (interlaced video)

Interlaced fields coded in field pictures (interlaced video)

Fields extracted from progressive frame coded in field pictures (interlaced video)

These picture types are indicated through the field_seq_flag in the video usability information (VUI) parameter set and the field indication supplemental enhancement information (SEI) messages.

However, support of decoding interlaced video, through the field indication SEI message and VUI parameter set exhibits several drawbacks. For one, a backward compatibility issue may exist. That is, some decoders do not recognize or are not configured to decode VUI and field indication SEI messages, and thus would ignore an indication of interlaced video and would output the decoded pictures as if the video was in a progressive scan format. Consequently, the resulting video quality can be seriously distorted, generating a poor user experience.

As another drawback, even for decoders configured to decode and parse VUI and field indication SEI messages, some conforming decoders may be implemented in way to ignore all SEI messages or only to handle a subset of them, e.g. buffering period SEI messages and picture timing SEI messages. Such decoders would also ignore the field indication SEI messages in a bitstream, and the same seriously distorted video quality can happen.

Furthermore, many video clients or players do not implement de-interlacing or other signal processing capabilities to appropriately handle picture types other than pictures that are progressive frames coded in frame pictures. Since SEI messages are not required to be recognized or processed by conforming decoders, a client or player with a conforming HEVC decoder that does not recognize field indication SEI messages would ignore the field indication SEI messages in such a bitstream and decode and output the decoded pictures as if the bitstreams only contained pictures that are progressive frames coded in frame pictures. Consequently, the resulting video quality can be sub-optimal. Furthermore, even for a client or a player with conforming HEVC decoder that does recognize and is able to process field indication SEI messages, all access units must be inspected to check the absence of field indication SEI messages and all the present field indication SEI messages have to be parsed and interpreted before a conclusion can be drawn that all pictures are progressive frames coded in frame pictures.

In view of these drawbacks, and as will be described in more detail below, various examples of the disclosure propose the following:
1) Signaling an indication of whether a coded video sequence contains interlaced fields or fields extracted from progressive frames (e.g., in the general_reserved_zero_{—}16 bits syntax element in the profile, tier and level syntax).
2) A simplification of the field SEI message syntax, by moving the progressive_source_flag from the SEI message to the VUI, and by removing from the SEI message the field_pic_flag, which is always equal to the field_seq_flag in the VUI.

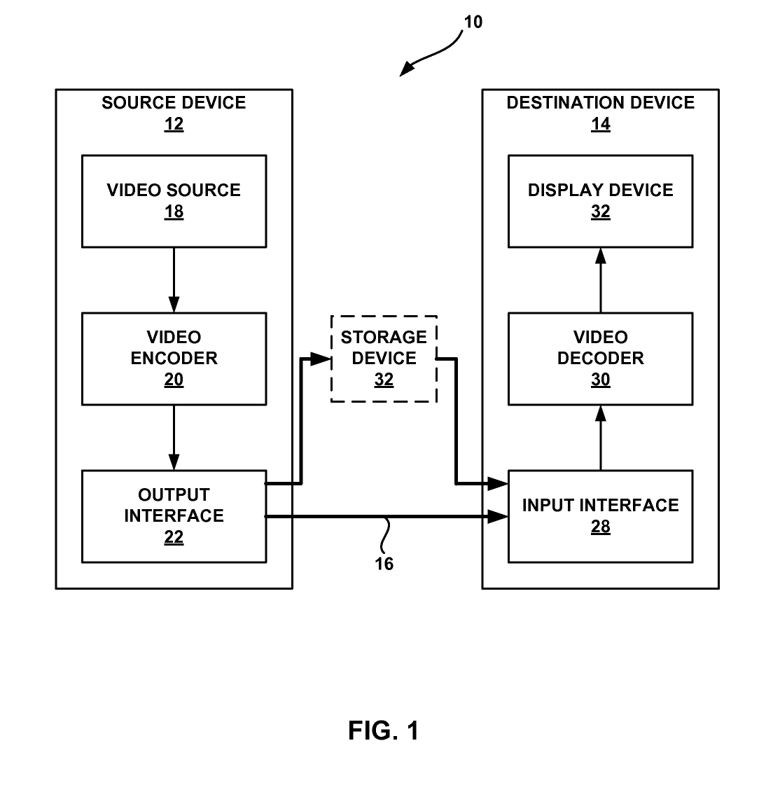

FIG. 1 is a block diagram illustrating an example video encoding and decoding system 10 that may utilize the techniques described in this disclosure. As shown in FIG. 1, system 10 includes a source device 12 that generates encoded video data to be decoded at a later time by a destination device 14. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via a link 16. Link 16 may comprise any type of medium or device capable of moving the encoded video data from source device 12 to destination device 14. In one example, link 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

Alternatively, encoded data may be output from output interface 22 to a storage device 32. Similarly, encoded data may be accessed from storage device 32 by input interface. Storage device 32 may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, storage device 32 may correspond to a file server or another intermediate storage device that may hold the encoded video generated by source device 12. Destination device 14 may access stored video data from storage device 32 via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from storage device 32 may be a streaming transmission, a download transmission, or a combination of both.

The techniques of this disclosure are not necessarily limited to wireless applications or settings. The techniques may be applied to video coding in support of any of a variety of multimedia applications, such as over-the-air television broadcasts, cable television transmissions, satellite television transmissions, streaming video transmissions, e.g., via the Internet, encoding of digital video for storage on a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes a video source 18, video encoder 20 and an output interface 22. In some cases, output interface 22 may include a modulator/demodulator (modem) and/or a transmitter. In source device 12, video source 18 may include a source such as a video capture device, e.g., a video camera, a video archive containing previously captured video, a video feed interface to receive video from a video content provider, and/or a computer graphics system for generating computer graphics data as the source video, or a combination of such sources. As one example, if video source 18 is a video camera, source device 12 and destination device 14 may form so-called camera phones or video phones. However, the techniques described in this disclosure may be applicable to video coding in general, and may be applied to wireless and/or wired applications.

The captured, pre-captured, or computer-generated video may be encoded by video encoder 20. The encoded video data may be transmitted directly to destination device 14 via output interface 22 of source device 12. The encoded video data may also (or alternatively) be stored onto storage device 32 for later access by destination device 14 or other devices, for decoding and/or playback.

Destination device 14 includes an input interface 28, a video decoder 30, and a display device 32. In some cases, input interface 28 may include a receiver and/or a modem. Input interface 28 of destination device 14 receives the encoded video data over link 16. The encoded video data communicated over link 16, or provided on storage device 32, may include a variety of syntax elements generated by video encoder 20 for use by a video decoder, such as video decoder 30, in decoding the video data. Such syntax elements may be included with the encoded video data transmitted on a communication medium, stored on a storage medium, or stored a file server.

Display device 32 may be integrated with, or external to, destination device 14. In some examples, destination device 14 may include an integrated display device and also be configured to interface with an external display device. In other examples, destination device 14 may be a display device. In general, display device 32 displays the decoded video data to a user, and may comprise any of a variety of display devices such as a liquid crystal display (LCD), a plasma display, an organic light emitting diode (OLED) display, or another type of display device.

Video encoder 20 and video decoder 30 may operate according to a video compression standard, such as the High Efficiency Video Coding (HEVC) standard presently under development by the Joint Collaboration Team on Video Coding (JCT-VC) of ITU-T Video Coding Experts Group (VCEG) and ISO/IEC Motion Picture Experts Group (MPEG). One Working Draft (WD) of HEVC, and referred to as HEVC WD8 hereinafter, is available from http://phenix.int-evry.fr/jct/doc_end_user/documents/10_Stockholm/wg11/JCTVC-J1003 -v8. zip.

A recent draft of the HEVC standard, referred to as “HEVC Working Draft 10” or “WD10,” is described in document JCTVC-L1003v34, Bross et al., “High efficiency video coding (HEVC) text specification draft 10 (for FDIS & Last Call),” Joint Collaborative Team on Video Coding (JCT-VC) of ITU-T SG16 WP3 and ISO/IEC JTC1/SC29/WG11, 12th Meeting: Geneva, C H, 14-23 Jan. 2013, which, as of Jul. 26, 2013, is downloadable from: http://phenix.int-evry.fr/jct/doc_end_user/documents/12_Geneva/wg11/JCTVC-L1003-v34.zip.

Another draft of the HEVC standard, is referred to herein as “WD10 revisions” described in Bross et al., “Editors' proposed corrections to HEVC version 1,” Joint Collaborative Team on Video Coding (JCT-VC) of ITU-T SG16 WP3 and ISO/IEC JTC1/SC29/WG11, 13^{th} Meeting, Incheon, K R, April 2013, which as of Jul. 26, 2013, is available from: http://phenix.int-evry.fr/jct/doc_end_user/documents/13_Incheon/wg11/JCTVC-M0432-v3.zip.

Video encoder 20 and video decoder 30 may also be configured to store video data in a certain file format, or transmit data according to real-time transport protocol (RTP) formats or through multimedia services.

File format standards include ISO base media file format (ISOBMFF, ISO/IEC 14496-12) and other file formats derived from the ISOBMFF, including MPEG-4 file format (ISO/IEC 14496-14), 3GPP file format (3GPP TS 26.244) and advanced video coding (AVC) file format (ISO/IEC 14496-15). Currently, an amendment to AVC file format for storage of HEVC video content is being developed by MPEG. This AVC file format amendment is also referred to as HEVC file format.

RTP payload formats include H.264 payload format in RFC 6184, “RTP Payload Format for H.264 Video”, scalable video coding (SVC) payload format in RFC 6190, “RTP Payload Format for Scalable Video Coding”, and many others. Currently, the HEVC RTP payload format is being developed by the Internet Engineering Task Force (IETF). RFC 6184 is available, as of Jul. 26, 2013, from http://tools.ietf.org/html/rfc6184, the entire content of which is incorporated by reference herein. RFC 6190 is available, as of Jul. 26, 2013, from http://tools.ietf.org/html/rfc6190, the entire content of which is incorporated by reference herein.

3GPP multimedia services include 3GPP dynamic adaptive streaming over HTTP (3GP-DASH, 3GPP TS 26.247), packet-switched streaming (PSS, 3GPP TS 26.234), multimedia broadcast and multicast service (MBMS, 3GPP TS 26.346) and multimedia telephone service over IMS (MTSI, 3GPP TS 26.114).

Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device.

The JCT-VC has developed the HEVC standard. The HEVC standardization efforts were based on an evolving model of a video coding device referred to as the HEVC Test Model (HM). The HM presumes several additional capabilities of video coding devices relative to existing devices according to, e.g., ITU-T H.264/AVC. For example, whereas H.264 provides nine intra-prediction encoding modes, the HM may provide as many as thirty-three intra-prediction encoding modes.

In general, the working model of the HM describes that a video frame or picture may be divided into a sequence of treeblocks or largest coding units (LCU) that include both luma and chroma samples. A treeblock has a similar purpose as a macroblock of the H.264 standard. A slice includes a number of consecutive treeblocks in coding order. A video frame or picture may be partitioned into one or more slices. Each treeblock may be split into coding units (CUs) according to a quadtree. For example, a treeblock, as a root node of the quadtree, may be split into four child nodes, and each child node may in turn be a parent node and be split into another four child nodes. A final, unsplit child node, as a leaf node of the quadtree, comprises a coding node, i.e., a coded video block. Syntax data associated with a coded bitstream may define a maximum number of times a treeblock may be split, and may also define a minimum size of the coding nodes.

A CU includes a coding node and prediction units (PUs) and transform units (TUs) associated with the coding node. A size of the CU generally corresponds to a size of the coding node and must typically be square in shape. The size of the CU may range from 8×8 pixels up to the size of the treeblock with a maximum of 64×64 pixels or greater. Each CU may contain one or more PUs and one or more TUs. Syntax data associated with a CU may describe, for example, partitioning of the CU into one or more PUs. Partitioning modes may differ between whether the CU is skip or direct mode encoded, intra-prediction mode encoded, or inter-prediction mode encoded. PUs may be partitioned to be non-square in shape. Syntax data associated with a CU may also describe, for example, partitioning of the CU into one or more TUs according to a quadtree. A TU can be square or non-square in shape.

The HEVC standard allows for transformations according to TUs, which may be different for different CUs. The TUs are typically sized based on the size of PUs within a given CU defined for a partitioned LCU, although this may not always be the case. The TUs are typically the same size or smaller than the PUs. In some examples, residual samples corresponding to a CU may be subdivided into smaller units using a quadtree structure known as “residual quad tree” (RQT). The leaf nodes of the RQT may be referred to as transform units (TUs). Pixel difference values associated with the TUs may be transformed to produce transform coefficients, which may be quantized.

In general, a PU includes data related to the prediction process. For example, when the PU is intra-mode encoded, the PU may include data describing an intra-prediction mode for the PU. As another example, when the PU is inter-mode encoded, the PU may include data defining a motion vector for the PU. The data defining the motion vector for a PU may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list (e.g., List 0, List 1, or List C) for the motion vector.

In general, a TU is used for the transform and quantization processes. A given CU having one or more PUs may also include one or more transform units (TUs). Following prediction, video encoder 20 may calculate residual values from the video block identified by the coding node in accordance with the PU. The coding node is then updated to reference the residual values rather than the original video block. The residual values comprise pixel difference values that may be transformed into transform coefficients, quantized, and scanned using the transforms and other transform information specified in the TUs to produce serialized transform coefficients for entropy coding. The coding node may once again be updated to refer to these serialized transform coefficients. This disclosure typically uses the term “video block” to refer to a coding node of a CU. In some specific cases, this disclosure may also use the term “video block” to refer to a treeblock, i.e., LCU, or a CU, which includes a coding node and PUs and TUs.

A video sequence typically includes a series of video frames or pictures. A group of pictures (GOP) generally comprises a series of one or more of the video pictures. A GOP may include syntax data in a header of the GOP, a header of one or more of the pictures, or elsewhere, that describes a number of pictures included in the GOP. Each slice of a picture may include slice syntax data that describes an encoding mode for the respective slice. Video encoder 20 typically operates on video blocks within individual video slices in order to encode the video data. A video block may correspond to a coding node within a CU. The video blocks may have fixed or varying sizes, and may differ in size according to a specified coding standard.

As an example, the HM supports prediction in various PU sizes. Assuming that the size of a particular CU is 2N×2N, the HM supports intra-prediction in PU sizes of 2N×2N or N×N, and inter-prediction in symmetric PU sizes of 2N×2N, 2N×N, N×2N, or N×N. The HM also supports asymmetric partitioning for inter-prediction in PU sizes of 2N×nU, 2N×nD, nL×2N, and nR×2N. In asymmetric partitioning, one direction of a CU is not partitioned, while the other direction is partitioned into 25% and 75%. The portion of the CU corresponding to the 25% partition is indicated by an “n” followed by an indication of “Up”, “Down,” “Left,” or “Right.” Thus, for example, “2N×nU” refers to a 2N×2N CU that is partitioned horizontally with a 2N×0.5N PU on top and a 2N×1.5N PU on bottom.

In this disclosure, “N×N” and “N by N” may be used interchangeably to refer to the pixel dimensions of a video block in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N.

Following intra-predictive or inter-predictive coding using the PUs of a CU, video encoder 20 may calculate residual data to which the transforms specified by TUs of the CU are applied. . The residual data may correspond to pixel differences between pixels of the unencoded picture and prediction values corresponding to the CUs. Video encoder 20 may form the residual data for the CU, and then transform the residual data to produce transform coefficients.

Following any transforms to produce transform coefficients, video encoder 20 may perform quantization of the transform coefficients. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

In some examples, video encoder 20 may utilize a predefined scan order to scan the quantized transform coefficients to produce a serialized vector that can be entropy encoded. In other examples, video encoder 20 may perform an adaptive scan. After scanning the quantized transform coefficients to form a one-dimensional vector, video encoder 20 may entropy encode the one-dimensional vector, e.g., according to context adaptive variable length coding (CAVLC), context adaptive binary arithmetic coding (CABAC), syntax-based context-adaptive binary arithmetic coding (SBAC), Probability Interval Partitioning Entropy (PIPE) coding or another entropy encoding methodology. Video encoder 20 may also entropy encode syntax elements associated with the encoded video data for use by video decoder 30 in decoding the video data.

To perform CABAC, video encoder 20 may assign a context within a context model to a symbol to be transmitted. The context may relate to, for example, whether neighboring values of the symbol are non-zero or not. To perform CAVLC, video encoder 20 may select a variable length code for a symbol to be transmitted. Codewords in VLC may be constructed such that relatively shorter codes correspond to more probable symbols, while longer codes correspond to less probable symbols. In this way, the use of VLC may achieve a bit savings over, for example, using equal-length codewords for each symbol to be transmitted. The probability determination may be based on a context assigned to the symbol.

Video coded according to HEVC may be displayed in an interlaced format, as opposed to a progressive scan format. In other examples, a progressive format may be used with HEVC. Interlaced video consists of two fields of a video frame captured at two different times. A field is an image that contains only half of the lines needed to make a complete image. Every odd line in the frame (i.e., the top field) is displayed, and then every even line in the frame is displayed (i.e., the bottom field). Progressive scan frames are video frames in which every line of the captured video is displayed sequentially (as opposed to only odd or even lines in interlaced video).

Previous proposals for HEVC include the specification of a field indication supplemental enhancement information (SEI message) for indicating that the video data is interlaced video. However, there are drawbacks with existing methods for indication of HEVC-based interlaced video with an SEI message. An HEVC bitstream may contain coded pictures that are in one or more interlaced formats, including interlaced field pictures, interleaved fields coded in frame pictures, or field pictures extracted from progressive frames. However, some video clients or players (e.g., video decoders) are not necessarily equipped with de-interlacing or other signal processing capabilities to appropriately decode and/or display such pictures. Rather, such video clients or players may typically only appropriately decode and display bitstreams wherein all pictures are progressive frames coded in frame pictures (i.e., progressive scan video).

Since SEI messages are not required to be recognized or processed by conforming HEVC decoders, a client or player with a conforming HEVC decoder that does not recognize field indication SEI messages would ignore such messages and decode and output the decoded interlaced pictures as if the bitstreams only contained pictures that are progressive frames coded in frame pictures. Consequently, the resulting video quality can be sub-optimal. Furthermore, even for a client or a player with a conforming HEVC decoder that does recognize, and is able to process field indication SEI messages, all access units must be inspected to check the existence of field indication SEI messages, and all present field indication SEI messages have to be parsed and interpreted before a conclusion can be drawn that all pictures are progressive frames coded in frame pictures. As such, detection of video in an interlaced format is cumbersome and adds complexity to the video decoder.

Other drawbacks relate to indicating the presence of interlaced video data in file formats, RTP payloads, and multimedia services. As one example, proposals for the HEVC file format lacks a mechanism to indicate HEVC-based interlaced video. With the current design of the HEVC file format, and the current design of HEVC itself, a player (e.g., decoder and display) implementing both HEVC and HEVC file format, but not equipped with proper handling (e.g. de-interlacing) of an interlaced video, may play an interlaced video as if the bitstreams only contained pictures that are progressive frames coded in frame pictures (i.e., in a progressive scan format). This may results in very poor video quality.

One proposed design for the HEVC RTP payload format also lacks a way to indicate HEVC-based interlaced video. With the current design of HEVC RTP payload format and the current design of HEVC itself, an RTP sender and an RTP receiver implementing both HEVC and HEVC RTP payload format would not be able to negotiate on the use of HEVC-based interlaced video, and the communication may occur with the two sides having different assumptions. For example, the sender may send an HEVC-based interlaced video, while the receiver accepts it and renders the video as if the bitstreams only contained pictures that are progressive frames coded in frame pictures. For streaming or multicast applications, where a client decides whether to accept a content or join a multicast session based on session description protocol (SDP), that includes a description of the content, clients not equipped with proper handling (e.g., de-interlacing) of an interlaced video, may mistakenly accept the content and play an interlaced video as if the bitstreams only contained pictures that are progressive frames coded in frame pictures.

In view of these drawbacks, the present disclosure presents techniques for improved signaling of an indication of whether or not video data includes interlaced video data. To address the first drawback involving field indication SEI messages, the following methods are provided to enable a decoder (e.g., video decoder 30) or a client (i.e., any device or software configured to decode video data) to determine whether or not the bitstream contains only coded pictures that are progressive frames coded as frame pictures (i.e., in a progressive scan format) without the need for the decoder to be able to recognize field indication SEI messages, and/or without the need for the decoder to process all field indication SEI messages in the bitstream to determine such a condition.

For this purpose, this disclosure proposes signaling an indication, e.g., syntax element or flag (general_progressive_frames_only_flag), in the encoded video bitstream. As one example, the general_progressive_frames_only_flag equal to 1 indicates that all pictures are progressive frames coded in frame pictures. The general_progressive_frames_only_flag equal to 1 also indicates that there are no field indication SEI messages. That is, since all pictures are in progressive scan format, no field indication SEI messages are necessary, as no video is in any type of SEI format. The general_progressive_frames_only_flag equal to 1 is equivalent to the syntax element field_pic_seq is equal to 0 and the syntax element progressive_source_flag is equal to 1. The syntax element field pic seq indicates whether or not any of the video data is coded in fields (i.e., interlaced video, such as an interlaced field coded in a field picture, or a field extracted from a progressive frame coded in a field picture). The syntax element progressive_source_flag indicates whether or not any of the video data was originally coded in a progressive scan format. The general_progressive_frames_only_flag equal to 0 indicates that the scan type may be interlaced, instead of progressive, or that some coded pictures may be coded field pictures instead of coded frame pictures. Alternatively, the semantics of the values 0 and 1 for the flag may be exchanged. It should be noted that the general_progressive_frames_only_flag indication is not necessarily limited to a two-bit flag, but may also be implemented as a multi-bit syntax element.

The general_progressive_frames_only_flag may be included in the encoded video bitstream in the video parameter set (VPS), sequence parameter set (SPS), or both. A VPS and an SPS are sets of parameters that apply to zero or more entire coded video sequences. As such, a general_progressive_frames_only_flag included in the VPS or SPS will apply to all coded video sequences associated with the VPS or SPS, respectively. A coded video sequence is a sequence of access units. Typically, a VPS will apply to more coded video sequences than an SPS.

The profile and level information (including the tier information) included in the VPS and/or SPS can be directly included in a higher system level (e.g., in a sample description of an HEVC track in an ISO based media file format file, in a session description protocol (SDP) file, or in a media presentation description (MPD)). Based on the profile and level information, the client (e.g., video streaming client or video telephony client) may decide to accept or choose contents or formats to consume. As such, in one example, the general_progressive_frames_only_flag may be included as part of the profile and level information, e.g., by using one bit in a reserved field (e.g., the general_reserved_zero_{—}16 bits field and/or the sub_layer_reserved_zero_{—}16 bits field[i]), as specified in HEVC WD8, to represent the above-mentioned interlace flag. Upon determining that the video scan type may be interlaced instead of progressive, or that some coded pictures may be coded field pictures instead of coded frame pictures, the decoder may reject such video to avoid a bad user experience.

Profiles and levels specify restrictions on bitstreams and hence limits on the capabilities needed to decode the bitstreams. Profiles and levels may also be used to indicate interoperability points between individual decoder implementations. Each profile specifies a subset of algorithmic features and limits that shall be supported by all decoders conforming to that profile. Each level specifies a set of limits on the values that may be taken by the syntax elements of a video compression standard. The same set of level definitions is used with all profiles, but individual implementations may support a different level for each supported profile. For any given profile, levels generally correspond to decoder processing load and memory capability.

As opposed to field indication SEI messages, HEVC-compatible decoders are required to be able to interpret syntax elements in the VPS and SPS. As such, any interlace flag included in the VPS or SPS will be parsed and decoded. Furthermore, since the VPS or SPS apply to more than one access unit, not every access unit must be checked for an indication of interlaced video, as in the case with field indication SEI messages.

The syntax and semantics of the profile, tier and level syntax and semantics are proposed to be changed as shown in bold below in Table 1.

TABLE 1

| profile_tier_level( ProfilePresentFlag, | |
|---|---|
| MaxNumSubLayersMinus1 ) { | Descriptor |
| if( ProfilePresentFlag ) { | |
| general_profile_space | u(2) |
| general_tier_flag | u(1) |
| general_profile_idc | u(5) |
| for( i = 0; i < 32; i++ ) | |
| general_profile_compatibility_flag[ i ] | u(1) |
| general_progressive_frames_only_flag | u(1) |
| general_reserved_zero_14bits | u(14) |
| } | |
| general_level_idc | u(8) |
| for( i = 0; i < MaxNumSubLayersMinus1; i++ ) { | |
| sub_layer_profile_present_flag[ i ] | u(1) |
| sub_layer_level_present_flag[ i ] | u(1) |
| if( ProfilePresentFlag && | |
| sub_layer_profile_present_flag[ i ] ) { | |
| sub_layer_profile_space[ i ] | u(2) |
| sub_layer_tier_flag[ i ] | u(1) |
| sub_layer_profile_idc[ i ] | u(5) |
| for( j = 0; j < 32; j++ ) | |
| sub_layer_profile_compatibility_flag[ i ][ j ] | u(1) |
| sub_layer_progressive_frames_only_flag[ i ] | u(1) |
| sub_layer_reserved_zero_14bits[ i ] | u(14) |
| } | |
| if( sub_layer_level_present_flag[ i ] ) | |
| sub_layer_level_idc[ i ] | u(8) |
| } | |
| } | |

As explained above, the syntax element general_progressive_frames_only_flag equal to 1 indicates that in the coded video sequence all the pictures are progressive frames coded in frame pictures and there is no field indication SEI message. The syntax element general_progressive_frames_only_flag equal to 0 indicates that in the coded video sequence there may be field indication SEI messages, and there may be frame pictures containing interlaced fields, field pictures containing interlaced fields, and field pictures containing fields extracted from progressive frames. coded pictures that are interlaced frames, interlaced fields, or progressive fields.

The syntax element general_reserved_zero_{—}14 bits shall be equal to 0 in bitstreams conforming to this Specification. Other values for general_reserved_zero_{—}14 bits are reserved for future use by ITU-T|ISO/IEC. Decoders shall ignore the value of general_reserved_zero_{—}14 bits.

The syntax elements sub_layer_profile_space[i], sub_layer_tier_flag[i], sub_layer_profile_idc[i], sub_layer_profile_compatibility_flag[i][j], sub_layer_progressive_frames_only_flag[i], sub_layer_reserved_zero_{—}14 bits[i], and sub_layer_level_idc[i] have the same semantics as general_profile_space, general_tier_flag, general_profile_idc, general_profile_compatibility_flag[j], general_progressive_frames_only_flag, general_reserved_zero_{—}14 bits, and general_level_idc, respectively, but apply to the representation of the sub-layer with TemporalId equal to i. When not present, the value of sub_layer_tier_flag[i] is inferred to be equal to 0.

For video decoders capable of handling interlaced video, this disclosure also proposes to alter the syntax and semantics of video usability information (VUI) and the field indication SEI message as shown in Table 2. VUI parameters are not required for constructing luma or chroma samples in the decoding process, but may be used to specify other characteristics of the video data, including the scan type (e.g., progressive or interlaced), and whether field or frame pictures are used. Altered syntax according to the techniques of the disclosure is shown in bold.

TABLE 2

| vui_parameters( ) { | Descriptor |
|---|---|
| aspect_ratio_info_present_flag | u(1) |
| if( aspect_ratio_info_present_flag ) { | |
| aspect_ratio_idc | u(8) |
| if( aspect_ratio_idc = = Extended_SAR ) { | |
| sar_width | u(16) |
| sar_height | u(16) |
| } | |
| } | |
| overscan_info_present_flag | u(1) |
| if( overscan_info_present_flag ) | |
| overscan_appropriate_flag | u(1) |
| video_signal_type_present_flag | u(1) |
| if( video_signal_type_present_flag ) { | |
| video_format | u(3) |
| video_full_range_flag | u(1) |
| colour_description_present_flag | u(1) |
| if( colour_description_present_flag ) { | |
| colour_primaries | u(8) |
| transfer_characteristics | u(8) |
| matrix_coefficients | u(8) |
| } | |
| } | |
| chroma_loc_info_present_flag | u(1) |
| if( chroma_loc_info_present_flag ) { | |
| chroma_sample_loc_type_top_field | ue(v) |
| chroma_sample_loc_type_bottom_field | ue(v) |
| } | |
| neutral_chroma_indication_flag | u(1) |
| field_seq_flag | u(1) |
| progressive_source_flag | u(1) |
| hrd_parameters_present_flag | u(1) |
| if( hrd_parameters_present_flag ) | |
| hrd_parameters( 1, sps_max_sub_layers_minus1 ) | |
| bitstream_restriction_flag | u(1) |
| if( bitstream_restriction_flag ) { | |
| tiles_fixed_structure_flag | u(1) |
| motion_vectors_over_pic_boundaries_flag | u(1) |
| max_bytes_per_pic_denom | ue(v) |
| max_bits_per_mincu_denom | ue(v) |
| log2_max_mv_length_horizontal | ue(v) |
| log2_max_mv_length_vertical | ue(v) |
| } | |
| } | |

Semantics of other VUI syntax elements not mentioned below may be the same as in HEVC WD8.

The syntax element field_seq_flag equal to 1 indicates that the coded video sequence conveys pictures that represent fields, and specifies that a field indication SEI message shall be present in every access unit of the current coded video sequence, e.g., where an access unit may generally refer to a set of network abstraction layer (NAL) units that are consecutive in decoder order and contain a coded picture. The syntax element field_seq_flag equal to 0 indicates that the coded video sequence conveys pictures that represent frames and that a field indication SEI message may or may not be present in any access unit of the current coded video sequence. When field_seq_flag is not present, it is inferred to be equal to 0.

It should be noted that the specified decoding process does not treat access units conveying pictures that represent fields or frames differently. A sequence of pictures that represent fields would therefore be coded with the picture dimensions of an individual field. For example, access units containing pictures that represent 1080i fields would commonly have cropped output dimensions of 1920×540, while the sequence picture rate would commonly express the rate of the source fields (typically between 50 and 60 Hz), instead of the source frame rate (typically between 25 and 30 Hz).

The syntax element progressive_source_flag equal to 1 indicates that the scan type of all pictures conveyed in the coded video sequence should be interpreted as progressive. The syntax element progressive_source_flag equal to 0 indicates that the scan type of all pictures conveyed in the coded video sequence should be interpreted as interlaced. When not present, the value of progressive_source_flag should be inferred to be equal to 1.

The interpretation of the combinations of field_seq_flag and progressive_source_flag values is defined in Table 3.

TABLE 3
Indicated interpretation of field_seq_flag and progressive_source_flag
for each of the pictures conveyed in a coded video sequence

| Interpretation | field_seq_flag | progressive_source_flag |
|---|---|---|
| Picture is a progressive frame | 0 | 1 |
| Picture is interleaved fields | 0 | 0 |
| coded in a frame picture | | |
| Picture is a field | 1 | 0 |
| Picture is a field extracted | 1 | 1 |
| from progressive frame | | |

TABLE 4
Field Indication SEI message

| field_indication( payloadSize ) { | Descriptor |
|---|---|
| [symbol] | [symbol] |
| [symbol] | [symbol] |
| duplicate_flag | u(1) |
| if( field_seq_flag ) | |
| bottom_field_flag | u(1) |
| else if( !progressive_source_flag ) | |
| top_field_first_flag | u(1) |
| else | |
| reserved_zero_1bit /* equal to 0 */ | u(1) |
| reserved_zero_6bits /* equal to 0 */ | u(6) |
| } | |

The field indication SEI message (syntax shown in Table 4) applies to the current access unit only. When an SEI network abstraction layer (NAL) unit contains a field indication SEI message, and has nuh_reserved_zero_{—}6 bits equal to 0, the SEI NAL unit shall precede, in decoding order, the first video coding (VCL) NAL unit in the access unit.

The presence of the field indication SEI message in the bitstream is specified as follows.
If field_seq_flag is equal to 1, one field indication SEI message shall be present in every access unit of the current coded video sequence.
Otherwise, if progressive_source_flag is equal to 1, no field indication SEI message shall be present in the current coded video sequence.
Otherwise, if progressive_source_flag is equal to 0, one field indication SEI message may be present in any access unit of the current coded video sequence.

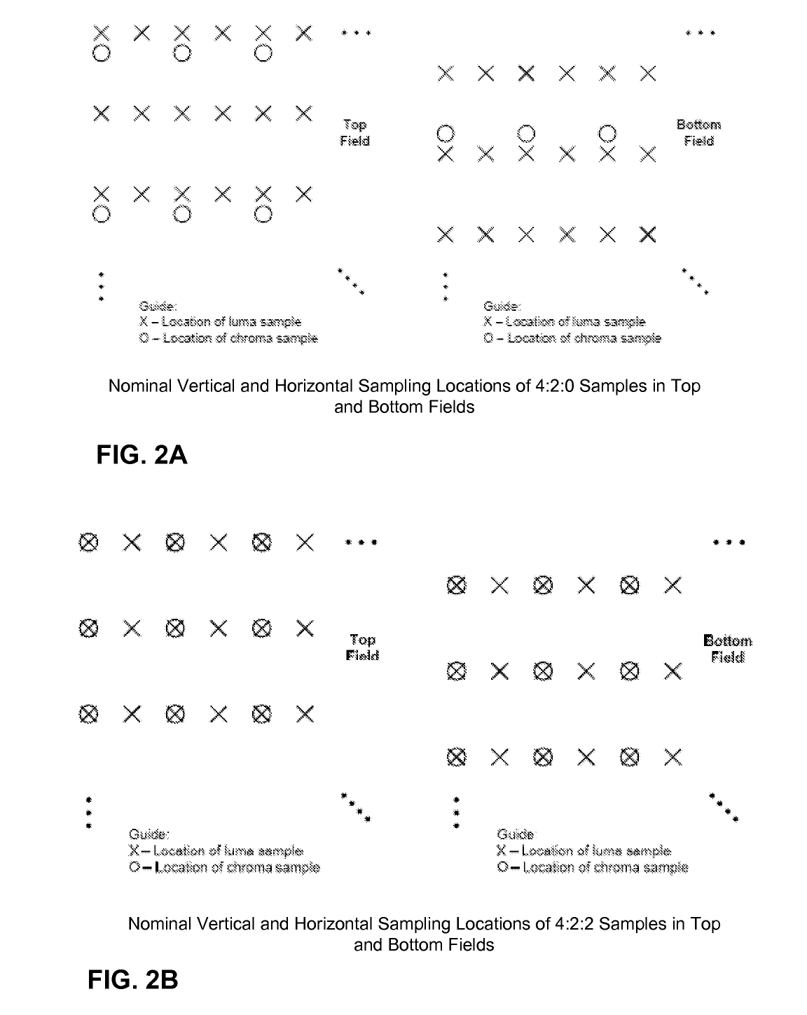

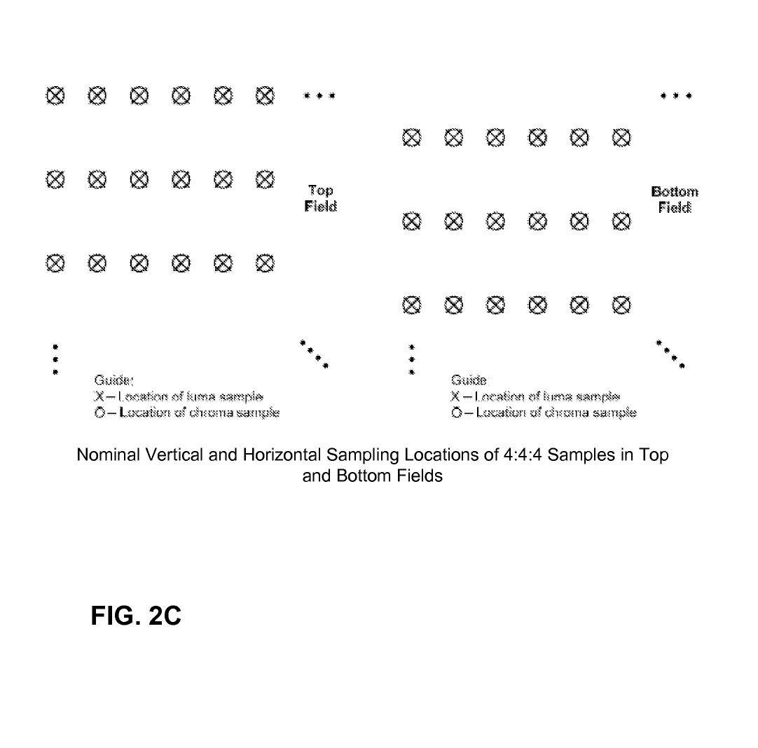

The nominal vertical and horizontal sampling locations of samples in top and bottom fields for 4:2:0, 4:2:2, and 4:4:4 chroma sampling formats are shown in FIGS. 2A, 2B and 2C.

The syntax element duplicate_flag equal to 1 indicates that the current picture is indicated to be a duplicate of a previous picture in output order. The syntax element duplicate_flag equal to 0 indicates that the current picture is not indicated to be a duplicate picture.

It should be noted that duplicate_flag should be used to mark coded pictures known to have originated from a repetition process such as 3:2 pull-down or other duplication and interpolation methods. The duplicate_flag would commonly be used when a video feed is encoded in a “transport pass-through” fashion, with known duplicate pictures tagged by setting duplicate_flag equal to 1.

When field_seq_flag is equal to 1 and duplicate_flag is equal to 1, it is assumed the access unit contains a duplicated field of the previous field in output order with the same parity as the current field.

The syntax element bottom_field_flag indicates the parity of the field contained within the access unit when field_seq_flag is equal to 1. The syntax element bottom_field_flag equal to 1 indicates bottom field parity. The syntax element bottom_field_flag equal to 0 indicates top field parity.

The syntax element top field first flag indicates the preferred field output order for display purposes when fields have been interleaved to form frames in a sequence of coded frames. If top_field_first_flag is equal to 1, the top field is indicated to be temporally first, followed by the bottom field. Otherwise (top_field_first_flag is equal to 0), the bottom field is indicated to be temporally first, followed by the top field.

The syntax element reserved_zero_{—}1 bit shall be equal to 0. The value 1 for reserved_zero_{—}1 bit is reserved for future backward-compatible use by ITU-T|ISO/IEC. Decoders shall ignore the value of reserved_zero_{—}1 bit.

The syntax element reserved_zero_{—}6 bits shall be equal to 0. Other values for reserved_zero_{—}6 bits are reserved for future backward-compatible use by ITU-T|ISO/IEC. Decoders shall ignore the value of reserved_zero_{—}6 bits.

The following section describes techniques for indicating interlaced video in an HEVC file format. As one example, an indication may be directly included in each sample entry of an HEVC track in an ISO based media file format file. For example, a flag in HEVCDecoderConfigurationRecord may be specified as, e.g., named progressive_frames_only_flag. This flag equal to 1 indicates that all pictures to which the sample entry containing the HEVC decoder configuration record applies are progressive frames coded in frame pictures (i.e., the scan type is progressive, and each coded picture is a coded frame). This flag equal to 0 indicates that the scan type of the pictures to which the sample entry applies may be interlaced instead of progressive, or indicates that some of the coded pictures may be coded field pictures instead of coded frame pictures. As another example, a similar signaling may be specified in the ISO base media file format, e.g., in VisualSampleEntry, such that it generically applies to video codecs.

This section describes techniques for indicating interlaced video in an RTP payload. RTP (Real-time Transport Protocol) is a protocol that defines a standardized packet format for transmitting audio and/or video over networks (e.g., Internet protocol networks). An RTP payload is the data being transmitted using an RTP packet, and it may include audio and/or video in a particular format (e.g., an HEVC video payload, H.264 video payload, MP3 audio payload, etc.).

As one example of the disclosure, an optional payload format parameter, e.g., named progressive-frames-only, may be specified, as follows. The progressive-frames-only parameter signals the properties of a stream or the capabilities of a receiver implementation. The value may be equal to either 0 or 1. When the parameter is not present, the value may be inferred to be equal to 1.

When the parameter is used to indicate the properties of a stream, the following applies. The value 1 indicates that, in the stream, coded pictures are all progressive frames coded in frame pictures (i.e., the scan type is progressive and each coded picture is a coded frame, and no field indication SEI message is present in the stream). The value 0 indicates that the scan type may be interlaced instead of progressive, or that some of the coded pictures may be coded field pictures. In this case there may be field indication SEI messages present in the stream. Of course, the semantics of values 0 and 1 may be reversed.

When the parameter is used for capability exchange or session setup, the following applies. The value 1 indicates that the entity supports, for both receiving and sending, only streams for which the scan type is progressive, that each coded picture is a coded frame, and that there is no field indication SEI message. The value 0 indicates that the entity supports, for both receiving and sending, streams for which the scan type may be progressive or interlaced, that coded pictures may be either frame pictures or field pictures, and that there may be field indication SEI messages.

The optional parameter progressive-frames-only, when present, may be included in the “a=fmtp” line of the SDP file. The parameter is expressed as a media type string, in the form of progressive-frames-only=1 or progressive-frames-only=0.

When an HEVC stream is offered over RTP using SDP in an Offer/Answer model for negotiation, the progressive-frames-only parameter is one of the parameters identifying a media format configuration for HEVC, and may be used symmetrically. That is, the answerer may either maintain the parameter with the value in the offer or remove the media format (payload type) completely.

When HEVC over RTP is offered with SDP in a declarative style, as in real-time streaming protocol (RTSP) or session announcement protocol (SAP), the progressive-frames-only parameter is used to indicate only stream properties, not the capabilities for receiving streams. In another example, a similar signaling may be specified in the SDP in general, not specific to HEVC, such that it generically applies to video codecs.

The following is another example of indicating interlaced video data in profile, tier, and level syntax. The syntax and semantics of the profile, tier and level are proposed to be signaled as follows.

| | |
|---|---|
| profile_tier_level( ProfilePresentFlag, | |
| MaxNumSubLayersMinus1 ) { | Descriptor |

| | |
|---|---|
| if( ProfilePresentFlag ) { | |
| general_profile_space | u(2) |
| general_tier_flag | u(1) |
| general_profile_idc | u(5) |
| for( i = 0; i < 32; i++ ) | |
| general_profile_compatibility_flag[ i ] | u(1) |
| general_progressive_frames_only_flag | u(1) |
| general_non_packed_only_flag | u(1) |
| general_reserved_zero_14bits | u(14) |
| } | |
| general_level_idc | u(8) |
| for( i = 0; i < MaxNumSubLayersMinus1; i++ ) { | |
| sub_layer_profile_present_flag[ i ] | u(1) |
| sub_layer_level_present_flag[ i ] | u(1) |
| if( ProfilePresentFlag && | |
| sub_layer_profile_present_flag[ i ] ) { | |
| sub_layer_profile_space[ i ] | u(2) |
| sub_layer_tier_flag[ i ] | u(1) |
| sub_layer_profile_idc[ i ] | u(5) |
| for( j = 0; j < 32; j++ ) | |
| sub_layer_profile_compatibility_flag[ i ][ j ] | u(1) |
| sub_layer_progressive_frames_only_flag[ i ] | u(1) |
| sub_layer_non_packed_only_flag[ i ] | u(1) |
| sub_layer_reserved_zero_14bits[ i ] | u(14) |
| } | |
| if( sub_layer_level_present_flag[ i ] ) | |
| sub_layer_level_idc[ i ] | u(8) |
| } | |
| } | |

The syntax element general_progressive_frames_only_flag equal to 1 indicates that, in the coded video sequence, all the pictures are progressive frames coded in frame pictures and there is no field indication SEI message. The syntax element general_progressive_frames_only_flag equal to 0 indicates that, in the coded video sequence, there may be field indication SEI messages, and there may be frame pictures containing interlaced fields, field pictures containing interlaced fields, and field pictures containing fields extracted from progressive frames.

The syntax element general_reserved_zero_{—}14 bits shall be equal to 0 in bitstreams conforming to this specification. Other values for general_reserved_zero_{—}14 bits are reserved for future use by ITU-T|ISO/IEC. Decoders shall ignore the value of general_reserved_zero_{—}14 bits.

The syntax element sub_layer_profile_space[i], sub_layer_tier flag[i], sub_layer_profile_idc[i], sub_layer_profile_compatibility_flag[i][j], sub_layer_progressive_frames_only_flag[i], sub_layer non_packed_only_flag[i], sub_layer_reserved_zero_{—}14 bits[i], and sub_layer_level_idc[i] have the same semantics as general_profile_space, general_tier_flag, general_profile_idc, general_profile_compatibility_flag[j], general_progressive_frames_only_flag, general non_packed_only_flag, general_reserved_zero_{—}14 bits, and general_level_idc, respectively, but apply to the representation of the sub-layer with TemporalId equal to i. When not present, the value of sub_layer_tier_flag[i] is inferred to be equal to 0.

In summary, in some examples, this disclosure proposes the following:
1) Signaling an indication of whether a coded video sequence contains interlaced fields or fields extracted from progressive frames (e.g., in the general_reserved_zero_{—}16 bits syntax element in the profile, tier and level syntax).
2) A simplification of the field SEI message syntax, by moving the progressive_source_flag from the SEI message to the VUI, and by removing from the SEI message the field_pic_flag, which is always equal to the field_seq_flag in the VUI.

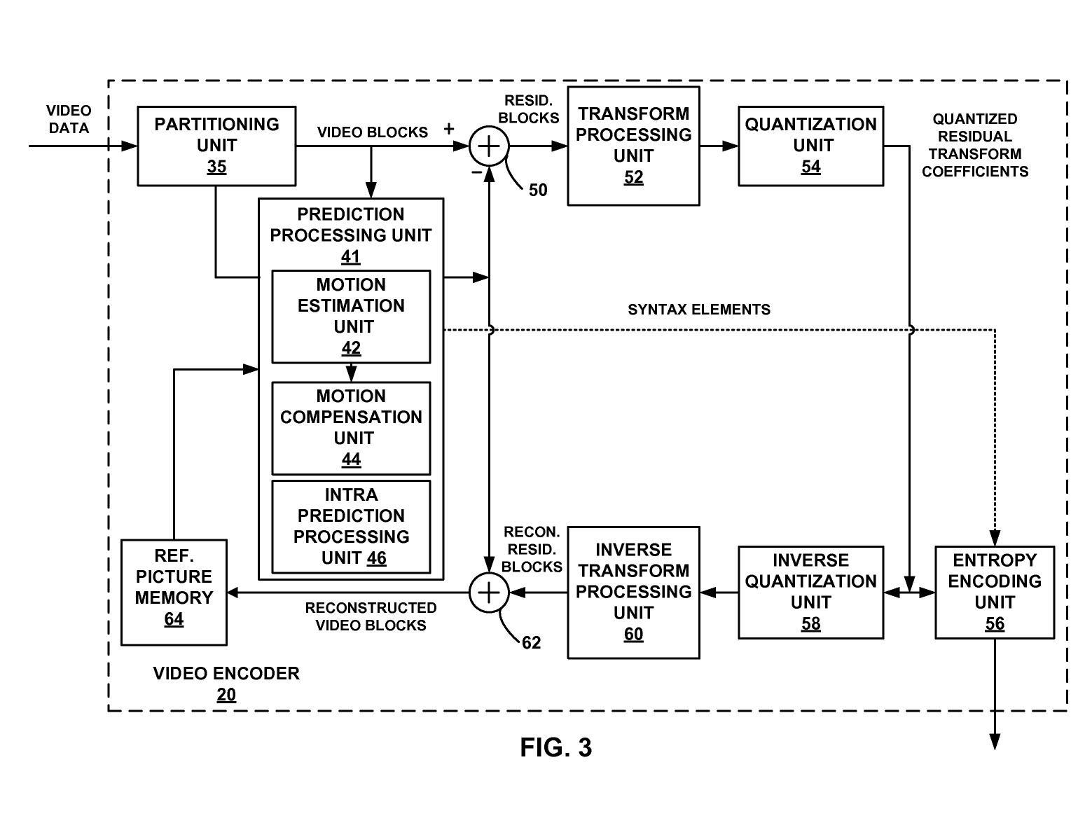

FIG. 3 is a block diagram illustrating an example video encoder 20 that may implement the techniques described in this disclosure. Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based compression modes. Inter-modes, such as uni-directional prediction (P mode) or bi-prediction (B mode), may refer to any of several temporal-based compression modes.

In the example of FIG. 3, video encoder 20 includes a partitioning unit 35, prediction processing unit 41, reference picture memory 64, summer 50, transform processing unit 52, quantization unit 54, and entropy encoding unit 56. Prediction processing unit 41 includes motion estimation unit 42, motion compensation unit 44, and intra prediction processing unit 46. For video block reconstruction, video encoder 20 also includes inverse quantization unit 58, inverse transform processing unit 60, and summer 62. A deblocking filter (not shown in FIG. 3) may also be included to filter block boundaries to remove blockiness artifacts from reconstructed video. If desired, the deblocking filter would typically filter the output of summer 62. Additional loop filters (in loop or post loop) may also be used in addition to the deblocking filter.

As shown in FIG. 3, video encoder 20 receives video data, and partitioning unit 35 partitions the data into video blocks. This partitioning may also include partitioning into slices, tiles, or other larger units, as wells as video block partitioning, e.g., according to a quadtree structure of LCUs and CUs. Video encoder 20 generally illustrates the components that encode video blocks within a video slice to be encoded. The slice may be divided into multiple video blocks (and possibly into sets of video blocks referred to as tiles). Prediction processing unit 41 may select one of a plurality of possible coding modes, such as one of a plurality of intra coding modes or one of a plurality of inter coding modes, for the current video block based on error results (e.g., coding rate and the level of distortion). Prediction processing unit 41 may provide the resulting intra- or inter-coded block to summer 50 to generate residual block data and to summer 62 to reconstruct the encoded block for use as a reference picture.

Intra prediction processing unit 46 within prediction processing unit 41 may perform intra-predictive coding of the current video block relative to one or more neighboring blocks in the same frame or slice as the current block to be coded to provide spatial compression. Motion estimation unit 42 and motion compensation unit 44 within prediction processing unit 41 perform inter-predictive coding of the current video block relative to one or more predictive blocks in one or more reference pictures to provide temporal compression.

Motion estimation unit 42 may be configured to determine the inter-prediction mode for a video slice according to a predetermined pattern for a video sequence. The predetermined pattern may designate video slices in the sequence as P slices, B slices or GPB slices. Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference picture.

A predictive block is a block that is found to closely match the PU of the video block to be coded in terms of pixel difference, which may be determined by sum of absolute difference (SAD), sum of square difference (SSD), or other difference metrics. In some examples, video encoder 20 may calculate values for sub-integer pixel positions of reference pictures stored in reference picture memory 64. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in reference picture memory 64. Motion estimation unit 42 sends the calculated motion vector to entropy encoding unit 56 and motion compensation unit 44.

Motion compensation, performed by motion compensation unit 44, may involve fetching or generating the predictive block based on the motion vector determined by motion estimation, possibly performing interpolations to sub-pixel precision. Upon receiving the motion vector for the PU of the current video block, motion compensation unit 44 may locate the predictive block to which the motion vector points in one of the reference picture lists. Video encoder 20 forms a residual video block by subtracting pixel values of the predictive block from the pixel values of the current video block being coded, forming pixel difference values. The pixel difference values form residual data for the block, and may include both luma and chroma difference components. Summer 50 represents the component or components that perform this subtraction operation. Motion compensation unit 44 may also generate syntax elements associated with the video blocks and the video slice for use by video decoder 30 in decoding the video blocks of the video slice.

Intra-prediction processing unit 46 may intra-predict a current block, as an alternative to the inter-prediction performed by motion estimation unit 42 and motion compensation unit 44, as described above. In particular, intra-prediction processing unit 46 may determine an intra-prediction mode to use to encode a current block. In some examples, intra-prediction processing unit 46 may encode a current block using various intra-prediction modes, e.g., during separate encoding passes, and intra-prediction processing unit 46 (or mode select unit 40, in some examples) may select an appropriate intra-prediction mode to use from the tested modes. For example, intra-prediction processing unit 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bit rate (that is, a number of bits) used to produce the encoded block. Intra-prediction processing unit 46 may calculate ratios from the distortions and rates for the various encoded blocks to determine which intra-prediction mode exhibits the best rate-distortion value for the block.

In any case, after selecting an intra-prediction mode for a block, intra-prediction processing unit 46 may provide information indicative of the selected intra-prediction mode for the block to entropy coding unit 56. Entropy coding unit 56 may encode the information indicating the selected intra-prediction mode in accordance with the techniques of this disclosure. Video encoder 20 may include in the transmitted bitstream configuration data, which may include a plurality of intra-prediction mode index tables and a plurality of modified intra-prediction mode index tables (also referred to as codeword mapping tables), definitions of encoding contexts for various blocks, and indications of a most probable intra-prediction mode, an intra-prediction mode index table, and a modified intra-prediction mode index table to use for each of the contexts.

After prediction processing unit 41 generates the predictive block for the current video block via either inter-prediction or intra-prediction, video encoder 20 forms a residual video block by subtracting the predictive block from the current video block. The residual video data in the residual block may be included in one or more TUs and applied to transform processing unit 52. Transform processing unit 52 transforms the residual video data into residual transform coefficients using a transform, such as a discrete cosine transform (DCT) or a conceptually similar transform. Transform processing unit 52 may convert the residual video data from a pixel domain to a transform domain, such as a frequency domain.

Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy encoding unit 56 entropy encodes the quantized transform coefficients. For example, entropy encoding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy encoding methodology or technique. Following the entropy encoding by entropy encoding unit 56, the encoded bitstream may be transmitted to video decoder 30, or archived for later transmission or retrieval by video decoder 30. Entropy encoding unit 56 may also entropy encode the motion vectors and the other syntax elements for the current video slice being coded.

Inverse quantization unit 58 and inverse transform processing unit 60 apply inverse quantization and inverse transformation, respectively, to reconstruct the residual block in the pixel domain for later use as a reference block of a reference picture. Motion compensation unit 44 may calculate a reference block by adding the residual block to a predictive block of one of the reference pictures within one of the reference picture lists. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reference block for storage in reference picture memory 64. The reference block may be used by motion estimation unit 42 and motion compensation unit 44 as a reference block to inter-predict a block in a subsequent video frame or picture.

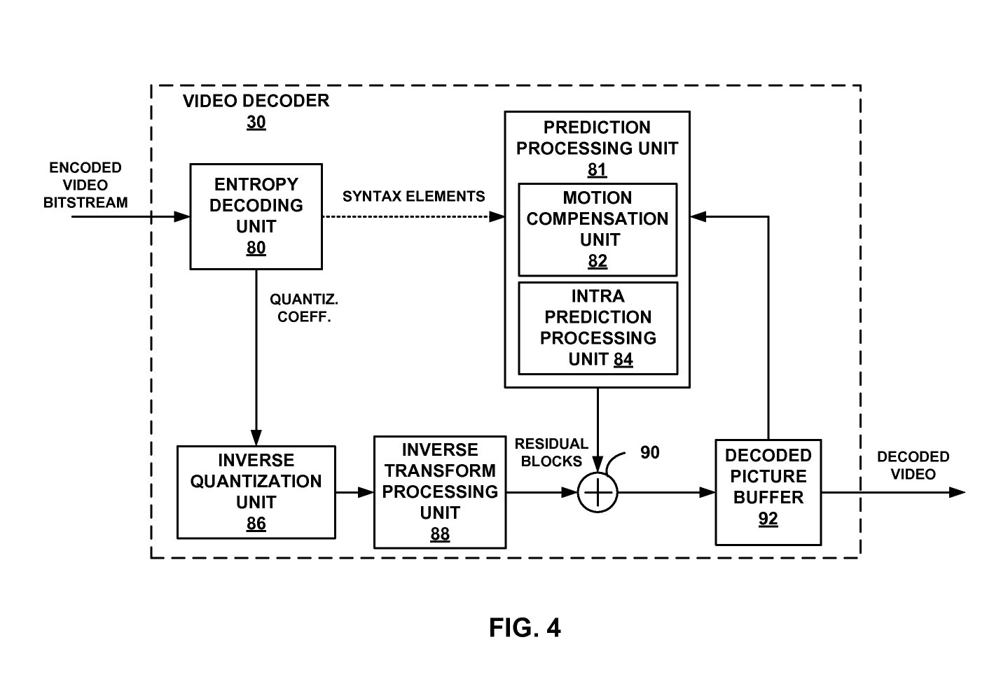

FIG. 4 is a block diagram illustrating an example video decoder 30 that may implement the techniques described in this disclosure. In the example of FIG. 4, video decoder 30 includes an entropy decoding unit 80, prediction processing unit 81, inverse quantization unit 86, inverse transformation unit 88, summer 90, and decoded picture buffer 92. Prediction processing unit 81 includes motion compensation unit 82 and intra prediction processing unit 84. Video decoder 30 may, in some examples, perform a decoding pass generally reciprocal to the encoding pass described with respect to video encoder 20 from FIG. 3.

During the decoding process, video decoder 30 receives an encoded video bitstream that represents video blocks of an encoded video slice and associated syntax elements from video encoder 20. Entropy decoding unit 80 of video decoder 30 entropy decodes the bitstream to generate quantized coefficients, motion vectors, and other syntax elements. Entropy decoding unit 80 forwards the motion vectors and other syntax elements to prediction processing unit 81. Video decoder 30 may receive the syntax elements at the video slice level and/or the video block level.

When the video slice is coded as an intra-coded (I) slice, intra prediction processing unit 84 of prediction processing unit 81 may generate prediction data for a video block of the current video slice based on a signaled intra prediction mode and data from previously decoded blocks of the current frame or picture. When the video frame is coded as an inter-coded (i.e., B, P or GPB) slice, motion compensation unit 82 of prediction processing unit 81 produces predictive blocks for a video block of the current video slice based on the motion vectors and other syntax elements received from entropy decoding unit 80. The predictive blocks may be produced from one of the reference pictures within one of the reference picture lists. Video decoder 30 may construct the reference frame lists, List 0 and List 1, using default construction techniques based on reference pictures stored in decoded picture buffer 92.

Motion compensation unit 82 determines prediction information for a video block of the current video slice by parsing the motion vectors and other syntax elements, and uses the prediction information to produce the predictive blocks for the current video block being decoded. For example, motion compensation unit 82 uses some of the received syntax elements to determine a prediction mode (e.g., intra- or inter-prediction) used to code the video blocks of the video slice, an inter-prediction slice type (e.g., B slice, P slice, or GPB slice), construction information for one or more of the reference picture lists for the slice, motion vectors for each inter-encoded video block of the slice, inter-prediction status for each inter-coded video block of the slice, and other information to decode the video blocks in the current video slice.

Motion compensation unit 82 may also perform interpolation based on interpolation filters. Motion compensation unit 82 may use interpolation filters as used by video encoder 20 during encoding of the video blocks to calculate interpolated values for sub-integer pixels of reference blocks. In this case, motion compensation unit 82 may determine the interpolation filters used by video encoder 20 from the received syntax elements and use the interpolation filters to produce predictive blocks.

Inverse quantization unit 86 inverse quantizes, i.e., de-quantizes, the quantized transform coefficients provided in the bitstream and decoded by entropy decoding unit 80. The inverse quantization process may include use of a quantization parameter calculated by video encoder 20 for each video block in the video slice to determine a degree of quantization and, likewise, a degree of inverse quantization that should be applied. Inverse transform processing unit 88 applies an inverse transform, e.g., an inverse DCT, an inverse integer transform, or a conceptually similar inverse transform process, to the transform coefficients in order to produce residual blocks in the pixel domain.

After motion compensation unit 82 generates the predictive block for the current video block based on the motion vectors and other syntax elements, video decoder 30 forms a decoded video block by summing the residual blocks from inverse transform processing unit 88 with the corresponding predictive blocks generated by motion compensation unit 82. Summer 90 represents the component or components that perform this summation operation. If desired, a deblocking filter may also be applied to filter the decoded blocks in order to remove blockiness artifacts. Other loop filters (either in the coding loop or after the coding loop) may also be used to smooth pixel transitions, or otherwise improve the video quality. The decoded video blocks in a given frame or picture are then stored in decoded picture buffer 92, which stores reference pictures used for subsequent motion compensation. Decoded picture buffer 92 also stores decoded video for later presentation on a display device, such as display device 32 of FIG. 1.

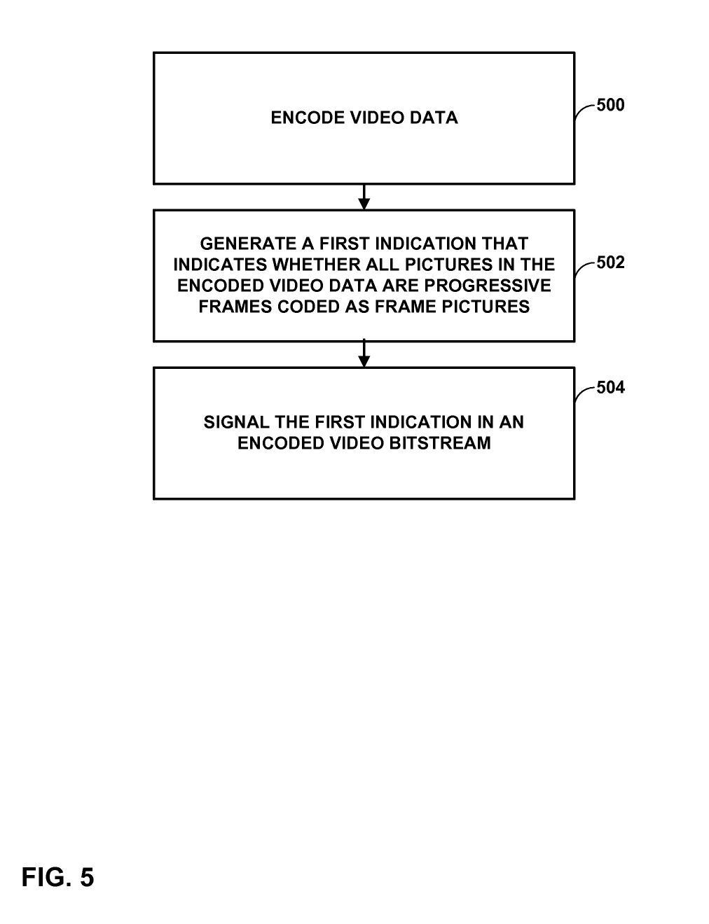

FIG. 5 is a flowchart illustrating an example video encoding method according to one example of the disclosure. The techniques of FIG. 5 may be carried out by one more structural units of video encoder 20.

As shown in FIG. 5, video encoder 20 may be configured to encode video data (500), generate a first indication that indicates whether all pictures in the encoded video data are progressive frames coded as frame pictures (502), and signal the first indication in an encoded video bitstream (504).

In one example of the disclosure, the first indication comprises a flag. The flag value equal to 0 indicates that all pictures in the encoded video data are progressive frames coded as frame pictures, and the flag value equal to 1 indicates that there may be one or more pictures in the encoded video data that are not progressive frames or not coded as frame pictures.

In one example of the disclosure, the first indication is signaled in at least one of a video parameter set (VPS) and a sequence parameter set (SPS). In another example of the disclosure, the first indication is signaled in a sample entry of a video file, e.g., in file format information. In another example of the disclosure, the first indication is signaled in one of a HEVCDecoderConfigurationRecord sample entry and a VisualSampleEntry sample entry. In another example of the disclosure, the first indication is a parameter in an RTP payload. In another example of the disclosure, the first indication is signaled in at least one of a profile syntax, a tier syntax, and a level syntax.

In another example of the disclosure, video encoder 20 may be further configured to generate a second indication indicating whether the encoded video data is coded as a field picture, and generate a third indication indicating whether the source of the encoded video data is in progressive scan or the interlaced format. The second indication with a value of 0 and the third indication with a value of 1 indicates that the encoded video data comprises progressive frames coded in frame pictures. The second indication with a value of 0 and the third indication with a value of 0 indicates that the encoded video data comprises interleaved fields coded in frame pictures. The second indication with a value of 1 and the third indication with a value of 0 indicates that the encoded video data comprises interlaced fields coded in field pictures. The second indication with a value of 1 and the third indication with a value of 1 indicates that the encoded video data comprises fields extracted from a progressive frame coded in field pictures.

In another example of the disclosure, the second indication is a field_seq_flag and the third indication is a progressive_source_flag, and wherein the field_seq_flag and the progressive_source_flag are coded in a video usability information (VUI) parameter set.

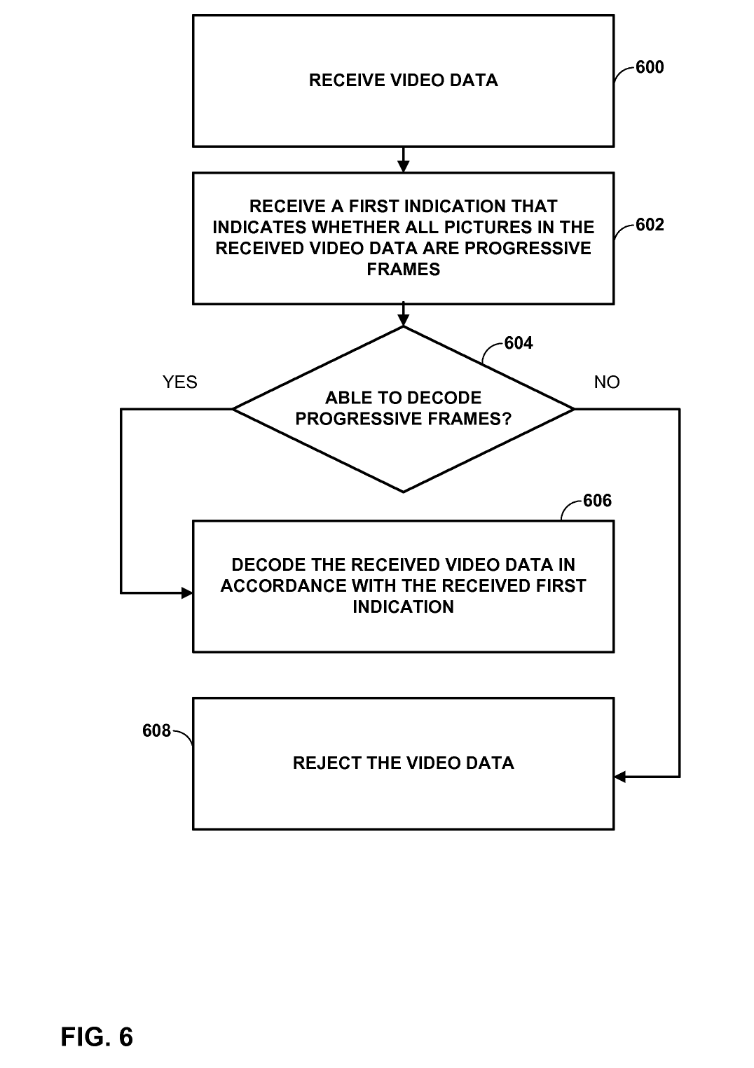

FIG. 6 is a flowchart illustrating an example video decoding method according to one example of the disclosure. The techniques of FIG. 6 may be carried out by one more structural units of video decoder 30.

As shown in FIG. 6, video decoder 30 may be configured to receive video data (600), and receive a first indication that indicates whether all pictures in the received video data are progressive frames coded as frame pictures (602). If video decoder 30 is not able to decode progressive frames (604), video decoder may reject the video data (608). If video decoder 30 is able to decode progressive frames, video decoder 30 is further configured to decode the received video data in accordance with the received first indication (606).

In one example of the disclosure, the first indication comprises a flag, and the flag value equal to 0 indicates that all pictures in the received video data are progressive frames coded as frame pictures, and the flag value equal to 1 indicates that there may be one or more pictures in the received video data that are not progressive frames or not coded as frame pictures.

In one example of the disclosure, the first indication is received in at least one of a video parameter set (VPS) and a sequence parameter set (SPS). In another example of the disclosure, the first indication is received in a sample entry of a video file format. In another example of the disclosure, the first indication is received in one of a HEVCDecoderConfigurationRecord sample entry and a VisualSampleEntry sample entry. In another example of the disclosure, the first indication is a parameter in an RTP payload. In another example of the disclosure, the first indication is received in at least one of a profile syntax, a tier syntax, and a level syntax.

In another example of the disclosure, video decoder 30 may be further configured to decode a second indication indicating whether the received video data is coded as a field picture, and decode a third indication indicating whether the source of the received video data is in progressive scan or the interlaced format. The second indication with a value of 0 and the third indication with a value of 1 indicates that the received video data comprises progressive frames coded in frame pictures. The second indication with a value of 0 and the third indication with a value of 0 indicates that the received video data comprises interleaved fields coded in frame pictures. The second indication with a value of 1 and the third indication with a value of 0 indicates that the received video data comprises interlaced fields coded in field pictures. The second indication with a value of 1 and the third indication with a value of 1 indicates that the received video data comprises fields extracted from a progressive frame coded in field pictures.

In another example of the disclosure, the second indication is a field_seq_flag and the third indication is a progressive_source_flag, and the field_seq_flag and the progressive_source_flag are coded in a video usability information (VUI) parameter set.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method for decoding video data, the method comprising:
receiving video data;
receiving a first indication that indicates whether all pictures in the received video data are progressive frames coded as frame pictures; and
decoding the received video data in accordance with the received first indication.

2. The method of claim 1, wherein the first indication comprises a flag, and wherein the flag value equal to 0 indicates that all pictures in the received video data are progressive frames coded as frame pictures, and wherein the flag value equal to 1 indicates that there may be one or more pictures in the received video data that are not progressive frames or not coded as frame pictures.

3. The method of claim 1, wherein the first indication indicates that there may be one or more pictures in the received video data that are not progressive frames or not coded as frame pictures, and wherein decoding the received video data comprises rejecting the video data.

4. The method of claim 1, further comprising receiving the first indication in at least one of a video parameter set and a sequence parameter set.

5. The method of claim 1, further comprising receiving the first indication in a sample entry of video file format information.

6. The method of claim 5, further comprising receiving the first indication in one of a HEVCDecoderConfigurationRecord sample entry and a VisualSampleEntry sample entry.

7. The method of claim 1, wherein the first indication is a parameter in a Real-time Transport Protocol (RTP) payload.

8. The method of claim 1, further comprising receiving the first indication in at least one of a profile syntax, a tier syntax, and a level syntax.

9. The method of claim 1, wherein decoding the received video data in accordance with the received first indication comprises:
decoding a second indication indicating whether the received video data is coded as a field picture;
decoding a third indication indicating whether the source of the received video data is in progressive scan or the interlaced format,
wherein the second indication with a value of 0 and the third indication with a value of 1 indicates that the received video data comprises progressive frames coded in frame pictures,
wherein the second indication with a value of 0 and the third indication with a value of 0 indicates that the received video data comprises interleaved fields coded in frame pictures,
wherein the second indication with a value of 1 and the third indication with a value of 0 indicates that the received video data comprises interlaced fields coded in field pictures, and
wherein the second indication with a value of 1 and the third indication with a value of 1 indicates that the received video data comprises fields extracted from a progressive frame coded in field pictures.

10. The method of claim 9, wherein the second indication is a field_seq_flag and the third indication is a progressive_source_flag, and wherein the field_seq_flag and the progressive_source_flag are coded in a video usability information (VUI) parameter set.

11. A method for encoding video data, the method comprising:
encoding video data;
generating a first indication that indicates whether all pictures in the encoded video data are progressive frames coded as frame pictures; and
signaling the first indication in an encoded video bitstream.

12. The method of claim 11, wherein the first indication comprises a flag, and wherein the flag value equal to 0 indicates that all pictures in the encoded video data are progressive frames coded as frame pictures, and wherein the flag value equal to 1 indicates that there may be one or more pictures in the encoded video data that are not progressive frames or not coded as frame pictures.

13. The method of claim 11, further comprising signaling the first indication in at least one of a video parameter set and a sequence parameter set.

14. The method of claim 11, further comprising signaling the first indication is signaled in a sample entry of video file format information.

15. The method of claim 14, further comprising signaling the first indication in one of a HEVCDecoderConfigurationRecord sample entry and a VisualSampleEntry sample entry.

16. The method of claim 11, wherein the first indication is a parameter in an Real-time Transport Protocol (RTP) payload.

17. The method of claim 11, further comprising signaling the first indication in at least one of a profile syntax, a tier syntax, and a level syntax.

18. The method of claim 11, further comprising:
generating a second indication indicating whether the encoded video data is coded as a field picture;
generating a third indication indicating whether the source of the encoded video data is in progressive scan or the interlaced format,
wherein the second indication with a value of 0 and the third indication with a value of 1 indicates that the encoded video data comprises progressive frames coded in frame pictures,
wherein the second indication with a value of 0 and the third indication with a value of 0 indicates that the encoded video data comprises interleaved fields coded in frame pictures,
wherein the second indication with a value of 1 and the third indication with a value of 0 indicates that the encoded video data comprises interlaced fields coded in field pictures, and
wherein the second indication with a value of 1 and the third indication with a value of 1 indicates that the encoded video data comprises fields extracted from a progressive frame coded in field pictures.

19. The method of claim 18, wherein the second indication is a field_seq_flag and the third indication is a progressive_source_flag, and wherein the field_seq_flag and the progressive_source_flag are coded in a video usability information (VUI) parameter set.

20. An apparatus configured to decode video data, the apparatus comprising:
a video decoder configured to:
receive video data;
receive a first indication that indicates whether all pictures in the received video data are progressive frames coded as frame pictures; and
decode the received video data in accordance with the received first indication.

21. The apparatus of claim 20, wherein the first indication comprises a flag, and wherein the flag value equal to 0 indicates that all pictures in the received video data are progressive frames coded as frame pictures, and wherein the flag value equal to 1 indicates that there may be one or more pictures in the received video data that are not progressive frames or not coded as frame pictures.

22. The apparatus of claim 20, wherein the first indication indicates that there may be one or more pictures in the received video data that are not progressive frames or not coded as frame pictures, and wherein decoding the received video data comprises rejecting the video data.

23. The apparatus of claim 20, wherein the video decoder is further configured to receive the first indication in at least one of a video parameter set and a sequence parameter set.

24. The apparatus of claim 20, wherein the video decoder is further configured to receive the first indication in a sample entry of video file format information.

25. The apparatus of claim 24, wherein the video decoder is further configured to receive the first indication in one of a HEVCDecoderConfigurationRecord sample entry and a VisualSampleEntry sample entry.

26. The apparatus of claim 20, wherein the first indication is a parameter in an Real-time transport protocol (RTP) payload.

27. The apparatus of claim 20, wherein the video decoder is further configured to receive the first indication in at least one of a profile syntax, a tier syntax, and a level syntax.

28. The apparatus of claim 20, wherein the video decoder is further configured to:
decode a second indication indicating whether the received video data is coded as a field picture;
decode a third indication indicating whether the source of the received video data is in progressive scan or the interlaced format,
wherein the second indication with a value of 0 and the third indication with a value of 1 indicates that the received video data comprises progressive frames coded in frame pictures,
wherein the second indication with a value of 0 and the third indication with a value of 0 indicates that the received video data comprises interleaved fields coded in frame pictures,
wherein the second indication with a value of 1 and the third indication with a value of 0 indicates that the received video data comprises interlaced fields coded in field pictures, and
wherein the second indication with a value of 1 and the third indication with a value of 1 indicates that the received video data comprises fields extracted from a progressive frame coded in field pictures.

29. The apparatus of claim 28, wherein the second indication is a field_seq_flag and the third indication is a progressive_source_flag, and wherein the field_seq_flag and the progressive_source_flag are coded in a video usability information (VUI) parameter set.

30. An apparatus configured to encode video data, the apparatus comprising:
a video encoder configured to:
encode video data;
generate a first indication that indicates whether all pictures in the encoded video data are progressive frames coded as frame pictures; and
signal the first indication in an encoded video bitstream.

31. The apparatus of claim 30, wherein the first indication comprises a flag, and wherein the flag value equal to 0 indicates that all pictures in the encoded video data are progressive frames coded as frame pictures, and wherein the flag value equal to 1 indicates that there may be one or more pictures in the encoded video data that are not progressive frames or not coded as frame pictures.

32. The apparatus of claim 30, wherein the video encoder is further configured to signal the first indication in at least one of a video parameter set and a sequence parameter set.

33. The apparatus of claim 30, wherein the video encoder is further configured to signal the first indication in a sample entry of video file format information.

34. The apparatus of claim 33, wherein the video encoder is further configured to signal the first indication in one of a HEVCDecoderConfigurationRecord sample entry and a VisualSampleEntry sample entry.

35. The apparatus of claim 30, wherein the first indication is a parameter in an Real-time Transport Protocol (RTP) payload.

36. The apparatus of claim 30, wherein the video encoder is further configured to signal the first indication in at least one of a profile syntax, a tier syntax, and a level syntax.

37. The apparatus of claim 30, wherein the video encoder is further configured to:
generate a second indication indicating whether the encoded video data is coded as a field picture;
generate a third indication indicating whether the source of the encoded video data is in progressive scan or the interlaced format,
wherein the second indication with a value of 0 and the third indication with a value of 1 indicates that the encoded video data comprises progressive frames coded in frame pictures,
wherein the second indication with a value of 0 and the third indication with a value of 0 indicates that the encoded video data comprises interleaved fields coded in frame pictures,
wherein the second indication with a value of 1 and the third indication with a value of 0 indicates that the encoded video data comprises interlaced fields coded in field pictures, and
wherein the second indication with a value of 1 and the third indication with a value of 1 indicates that the encoded video data comprises fields extracted from a progressive frame coded in field pictures.

38. The apparatus of claim 37, wherein the second indication is a field_seq_flag and the third indication is a progressive_source_flag, and wherein the field_seq_flag and the progressive_source_flag are coded in a video usability information (VUI) parameter set.

39. An apparatus configured to decode video data, the apparatus comprising:
means for receiving video data;
means for receiving a first indication that indicates whether all pictures in the received video data are progressive frames coded as frame pictures; and
means for decoding the received video data in accordance with the received first indication.

40. An apparatus configured to encode video data, the method comprising:
means for encoding video data;
means for generating a first indication that indicates whether all pictures in the encoded video data are progressive frames coded as frame pictures; and
means for signaling the first indication in an encoded video bitstream.

41. A computer-readable storage medium storing instructions that, when executed, cause one or more processors of a device configured to decode video data to:
receive video data;
receive a first indication that indicates whether all pictures in the received video data are progressive frames coded as frame pictures; and
decode the received video data in accordance with the received first indication.

42. A computer-readable storage medium storing instructions that, when executed, cause one or more processors of a device configured to encode video data to:
encode video data;
generate a first indication that indicates whether all pictures in the encoded video data are progressive frames coded as frame pictures; and
signal the first indication in an encoded video bitstream.
